(19) United States
(12) Patent Application Publication
(10) Pub. No.: US 2005/0111086 A1
(43) Pub. Date: May 26, 2005

(54) Stereo microscope

(75) Inventors: Johannes Knoblich, Jena (DE); Thomas Serfling, Jena (DE); Tobias Kaufhold, Jena (DE); Guenter Osten, Jena (DE); Detlef Hein, Jena (DE)

Correspondence Address: Gerald H. Kiel, Esq.;REED SMITH LLP, 599 Lexington Avenue, New York, NY, 10022-7650, US

(73) Assignee: CARL ZEISS JENA GmbH

(21) Appl. No.: 10/993,620

(22) Filed: Nov. 19, 2004

(30) Foreign Application Priority Data
Nov. 21, 2003 (DE) 103 55 529.3

(51) Int. Cl. G02B 21/00

(52) U.S. Cl. 359/368; 359/381

(57) ABSTRACT

The invention is directed to a stereo microscope with electrically controllable components which is characterized in that it is highly user-friendly and ergonomic. For this purpose, all essential components are provided with an electric control or status detection and are interconnected by a network. A common all-purpose operator console is advantageously provided.

### CROSS-REFERENCE TO RELATED APPLICATION

This application claims priority of German Application No. 103 55 529.3, filed November 21, 2004, the complete disclosure of which is hereby incorporated by reference.

a) Field of the Invention

The invention is directed to a stereo microscope with electrically controllable components which is characterized in that it is highly user-friendly and ergonomic.

b) Description of the Related Art

Modern stereo microscopes are often constructed in a modular manner so that they can easily be adapted to different tasks. In the prior art, the individual optical and mechanical components of these stereo microscope systems are functionally autonomous in themselves and are also operated per component. However, when combining different components, interactions between the components must sometimes be taken into consideration. These interactions must be recognized and taken into account by the user. For example, in many transmitted light illumination devices the illuminated object field must be manually adapted to the different, optional objectives by switchable adapting optics.

Because of the mirrors, diaphragms, etc. which are generally displaceable continuously for adapting in the manner described above, it is impossible to reproduce the adjustments exactly and when changing users the new user must reset the stereo microscope system manually every time. This is also true for different cases of application performed by an individual user.

Because of the modular construction, the operator controls are generally arranged directly at the components and are therefore usually not arranged in an ergonomically favorable manner. It is also known to arrange the operator controls for an individual component in a separate remote control. In that case, there may be a plurality of remote controls next to one another which cannot be distinguished from one another without looking at them and which also require too much space. For the user, the state of the total system can only be determined by means of visual inspection; concise, rapidly intelligible information about the position and operation of the various components is not possible.

When the total magnification changes, the depth of focus of the microscope also changes. Therefore, in order to focus in a precise and sensitive manner after changing the magnification it is also necessary to change the gear ratio of the focusing movement. For this reason, it is known to provide a coarse mode and a fine mode, but this gradation does not meet the needs of the user.

Further, the brightness of the image changes when the magnification and/or aperture changes and, therefore, the brightness must be adapted manually in a corresponding manner after the change.

An autofocus system for a microscope system is described in DE 101 13 084 A1. Image sharpness feedback information is used to readjust the focus position and control of an objective changer and/or of a possible zoom is also provided.

DE 101 06 696 A1 discloses a height-adjustable tube which has swivelable correction elements. The correlation between the controlled correction elements and the adjusted height is carried out by means of suitable sensors inside the tube. [0010] An expanded diaphragm control for fading in images in a stereo microscope is described in DE 101 57 613 Al by Leica. In this reference, diaphragms are controlled depending upon the application and the wishes of the user. Corresponding sensors are provided for reporting position and control devices are provided for coordinating and linking to an external video controller for the data that are reflected in and to an external operating control device. User-specific storage of diaphragm settings are provided. The communication with the external video controller is limited to influencing the image by fading in the status of the diaphragm control. Communication with the external operating control is likewise limited to fading or blending the status into the left or right main beam path. The communication of the system is fixed and can not be adapted by the consumer to an automated environment. Feedback information about status is only carried out by the sensors inside the diaphragm control assembly. Accordingly, the status of other components and, therefore, the total state of the system cannot be determined or displayed.

DE 195 37 868 A1 describes an illumination device for a stereo microscope whose illumination-side intercept length is adapted to the actual image-side intercept length of a zoom objective. In this case, a fixed coupling mechanism is provided between the adjustable optics elements for varying magnification in the imaging beam path and the optics elements for the illumination intercept length to be adjusted. There is apparently no link to other components, so that this is a matter of an isolated solution.

### OBJECT AND SUMMARY OF THE INVENTION

It is the primary object of the invention to develop a stereo microscope system in which the user is relieved of routine tasks and assisted in solving problems of application also in an ergonomic respect and which is so variable that it can be expanded and also easily incorporated in an automated environment at any time.

According to the invention, this object is met in a stereo microscope comprising a plurality of connectable or adjustable components including an illumination device, focus drive, and zoom objective. The components have an electric control and/or an electric status detection device for detecting the switching state or the adjustment of the components. A connection is provided between the components for exchanging control commands or status information.

The system, according to the invention, for stereo microscopy is characterized in that all of the essential components (preferably also components that are not motor-operated in the prior art and which therefore had to be operated manually by the user heretofore) can be electronically controlled or detected, in that all relevant operating states and adjustments can be accessed, and in that completely novel functionalities are provided for stereo microscopy by means of a suitable evaluation and further processing of this information in the interplay of the components. In this respect, it is particularly advantageous when these components have autointelligence, i.e., they can not only respond to commands of a central entity but can also evaluate status information of other components and turn it into their own adapted changes in state.

### BRIEF DESCRIPTION OF THE DRAWING

In the drawing:

FIG. 1 shows an application example for a total stereo microscope system of the kind mentioned above whose construction will be described in the following. and

FIG. 2 shows an embodiment example for the wiring of the total system using the reference numbers from FIG. 1.

### DESCRIPTION OF THE PREFERRED EMBODIMENTS

Every motor-operated or encoded component is connected by a CAN bus system or other suitable data bus system to the total system. In the embodiment example, the following components participate in the data exchange: the motor-operated zoom body MZK, motor-operated focus drive MFT, encoded objective changer with three objectives COW (of course, the objective changer can also be fully motor-operated, the encoded variant being merely one embodiment form), motor-operated transmitted light illumination MDL, motor-operated height-adjustable intermediate tube MHZ, display eyepiece AO, cold light source for transmitted light illumination KLD, cold light source for incident light illumination KLA, light shunt LW, electronics module EM, ergonomic operator console EBP, and a PC. A digital intermediate tube with a digital camera which can also exchange data with the total system is not shown but may also be connected. Commercially available cameras K can also communicate with the total system via the PC with suitable interfaces; the PC also offers the possibility of external communication, e.g., via the Internet.

In the stereo microscope itself, data concerning the connected components are compiled in the electronics module EM to which the operator console EBP is also connected. The compiled data about the states of the individual components can be viewed by the user on the operator console or also on an external display, not shown.

The electronics module EM and the light shunt LW are arranged under the cold light sources KLD and KLA, which are required in any case, and therefore do not require additional surface space. The cold light sources KLD and KLA are, for example, commercially available SCHOTT high-output cold light sources KL2500LCD and can be remote-controlled with respect to color temperature via the existing remote control socket. The control of brightness is carried out electronically in the motor-operated transmitted light device MDL and in the light shunt LW.

Further, every component can have the operator controls for its basic functions. The advantages of the solution according to the invention can be realized by using the common operator console EBP. All states of the controllable components of the total system can be interrogated and adjusted with this operator console EBP. The operator controls most often needed, for focusing and zoom, can also be used with high operating reliability without looking at them. The operator console EBP is ergonomically shaped. The setup location for the operator console EBP may be chosen freely by the user and, therefore, substantially more ergonomic operating conditions can be achieved by the remote control.

Controls for hands-free operation, e.g., by means of a footswitch or voice control, can also be incorporated in the system so that the user's hands are free to manipulate the object.

The connection of a PC makes it possible, when incorporated in a network (e.g., the Internet or a local network), to remotely control the stereo microscope system over large spatial distances. By means of this network, several stereo microscopes can also be controlled proceeding from a central entity, which is particularly advantageous in automated timed production lines or the like

Further, the whole system can be automated directly by the user on the PC by means of macro programming (e.g., by Visual Basic™) and can therefore be economically incorporated in existing process chains, e.g., for process monitoring at a plurality of locations. The programming of the system can be action-controlled and/or time-controlled. The macros can also be generated and retrieved again without a PC by means of the operator console EBP. Further, operating sequences can be loaded into the control unit and selected and started by means of the operator console EBP.

Several complete microscopes can also be interconnected without a network by means of the CAN bus and can be controlled centrally as a total system with an operator console EBP.

The system according to the invention is suited to assist work with databases in that the device state or settings of the components essential to image generation are stored together with photographic or digital-photographic recordings. Therefore, it is also suitable for purposes of documentation, i.e., the adjustments during the operation of the stereo microscope can be detected and stored together with the images without manual effort and additional information can also be detected and stored.

All of the adjustments can be stored in a user-specific manner and reproduced so as to save time and reproduce adjustments with increased accuracy when there is a change of users and/or a change of tasks, particularly when settings are determined empirically. Good, fast reproducibility is advantageous particularly for the numerous illumination variants and is supported particularly by the light shunt LW with a plurality of dimmable outputs for each lightguide with a connection for the KL1500LCD and the motor-operated transmitted light device. Any combinations of illumination can also be generated with this arrangement with mixed light. Therefore, film sequences with changing illumination ratios can also be recorded by means of suitable receivers.

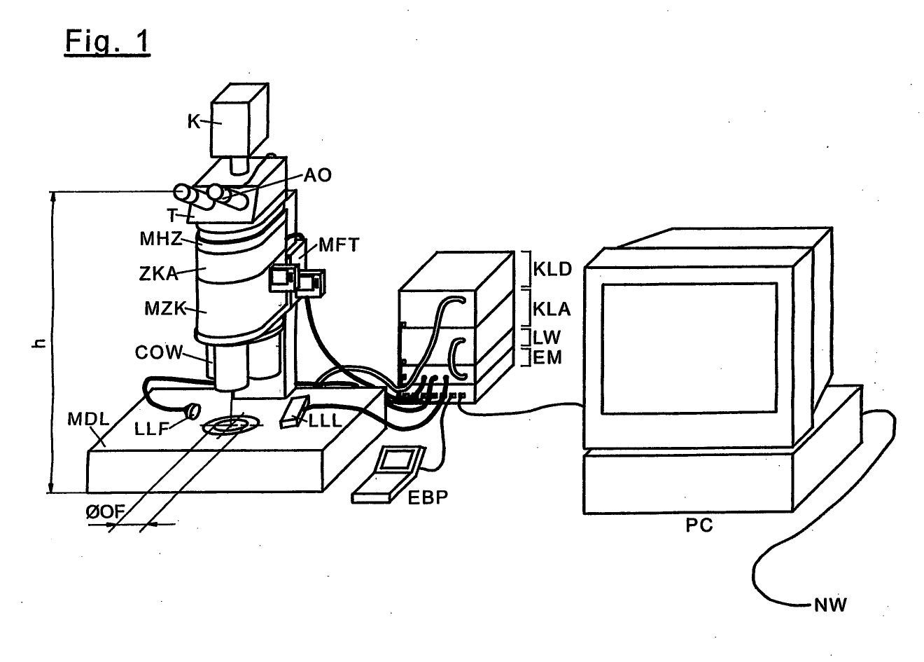

In FIG. 1, a lightguide with a focusing attachment LLF and a lightguide with a line light LLL are supplied by means of the light shunt LW of the intermediate tube for coaxial incident light illumination ZKA. Alternatively, other variants of slit ring lights for darkfield and brightfield illumination, point-ring lights, diverse lightguides with or without focusing attachments and/or filters, etc. can also be used,

Structured LED illumination known, e.g., from DE 37 34 691, can also be used for illumination.

By means of suitable programming, the system can have autointelligence and can therefore relieve the user of some of the routine tasks and will not even suggest or display redundant or disadvantageous possible adjustments. This autointelligence can also be deactivated by the user if necessary.

Some advantageous examples for realizing the invention are listed in the following. In a motor-operated, height-adjustable intermediate tube MHZ for adapting the system to an ergonomically favorable viewing height h, this viewing height h, once it has been adjusted, can be maintained constant by means of the evaluation of the current status data of the total system within the framework of the adjusting range of the intermediate tube MHZ. The routine work of readjusting the viewing height is accordingly transferred from the user to the system.

The compensation of stored focuses for different objectives (parfocality compensation) can likewise be taken over by the system. For this purpose, the objective is detected by means of the position of the coded (or motor-operated) objective changer COW. The associated stored focus is also known with the objective and can be adapted to the previously used objective by means of the motor-operated focusing drive.

The sensitivity for the focusing movement can be preadjusted automatically by means of evaluating the data for the current total magnification and accordingly leads to an adapted gear ratio that is always optimal.

The brightness of illumination can be regulated by the receiver signals of a suitable receiver (e.g., an external digital camera with accessible data for measurement of exposure or a digital camera integrated in an intermediate tube) within an operating range that is optimal for the receiver. The color temperature and the brightness of illumination, for example, can be adapted to the receiver. With respect to the color temperature, the adapting is carried out directly at the cold light sources KLD and KLA and, with respect to brightness, in the motor-operated transmitted light illumination MDL and the light shunt LW.

Further, the system is capable of maintaining the brightness of illumination that is used constant at a desired adjustable value through the evaluation of information about the total state of the system or changes in this total state (zoom factor, objective factor, aperture) by means of the above-mentioned color-neutral brightness adjustment in the elements MDL and LW. The routine work of readjusting the brightness is accordingly taken over from the user by the system.

The system is capable of adapting the transmitted light brightfield illumination to the imaged visual field or object field ØOF through the evaluation of the information about the total state of the system (zoom factor, objective factor) by means of adapting optics, a light zoom and/or an iris diaphragm. This prevents stray light that worsens contrast and the routine work of adapting illumination to the visual field is shifted from the user to the system.

The transmitted light darkfield illumination can be adapted to the objective that is used by evaluating the information about the total state of the system (working distance of the objective, free diameter of the objective) by means of an iris diaphragm, so that no direct light is coupled into the objective and the maximum possible illumination intensity can nevertheless be used for darkfield illumination. Ideally, the same iris diaphragm can be used for brightfield and darkfield illumination when both type of illumination are provided in a common motor-operated transmitted light illumination MDL.

Once it has been pre-configured with respect to illumination, the system can automatically select the best illumination method with the optimal additional system parameters for a certain task according to freely determinable criteria by evaluating the image information determined with a suitable image receiver (e.g., a digital camera) by means of image processing software. For example, it is possible to classify objects as high-contrast, low-contrast, reflecting and absorbing objects. The minimum and maximum intensities occurring in the image with their distribution over the image can be evaluated. With a greater distance between minimum and maximum intensity (high-contrast image), a diffuse illumination that brightens the dark areas is ideal, while a directed illumination is advantageous in a low-contrast image. Absorbing objects allow only small maximum values; reflecting materials generate very high maximum values, so that the intensity of the illumination can be adjusted in a corresponding manner. The insights concerning illumination that are gained on an individual basis can also be transferred to a specific selection routine for illumination by means of suitable macro programs.

Further, the system gives the user useful information that is not available to the user in known systems. For example, the resolution calculated by taking into account the optical data (known to the system) or the control state of segmented LED illumination is displayed. This information can be displayed by reflecting into the eyepiece or can be displayed on the operator console EBP. Other automatically displayed useful information includes the measuring uncertainty which is important for measuring in the z-direction and which can be determined automatically by interrogating the operating states and the depth of focus calculated therefrom.

The system according to the invention makes it possible to measure in the XY object plane also without calibration on the part of the consumer. This calibration can be dispensed with because the relevant components can be calibrated in the factory, the calibration data can remain stored in the system, and all relevant data are available by interrogating the operating states.

User comfort can be further increased by means of a motor-operated object table with an additional axis of rotation. This can also be incorporated in the system.

The images from different illumination situations can be superimposed and/or subjected to further image processing in order to bring out characteristics of the object more clearly or to make them visible at all. This can also be linked to a success control, i.e., when results are still unsatisfactory, parameters are changed and a new success control is carried out. The total system only needs to be programmed in a corresponding manner for this purpose.

The left image and the right image are recorded (e.g., each with a digital camera) by means of the stereo microscope, a true three-dimensional model is generated therefrom by computer and can be further evaluated by means of the automated total system and can also be displayed three-dimensionally by suitable methods (e.g., with shutter glasses or methods for autostereoscopic viewing). The data about the stereo basis, magnification, etc. necessary for generating the stereo model can likewise be interrogated by the system.

The system can be used for quality control and the measurement results or other information from the image of the stereo microscope which can be evaluated, e.g., by means of image processing, can automatically be used as a controlled condition for the upstream manufacturing process. This means that the stereo microscope system can be linked to the upstream manufacturing process in order to improve manufacturing quality. The comparison of the measured or imaged objects with virtual software models enables fast decisions. Not only actual values based on two-dimensional measurements, but also those based on three-dimensional measurements can be compared with reference values, e.g., originating from the CAD design, and feedback to the production process can be realized in the event of deviations.

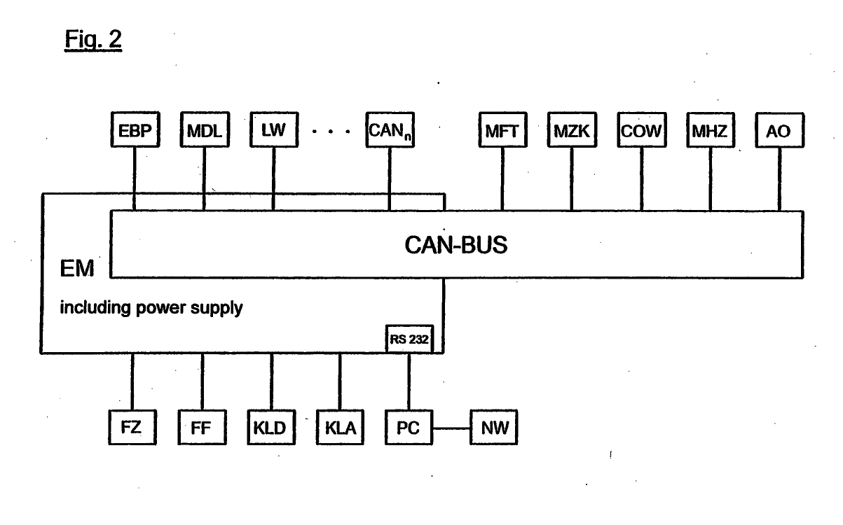

FIG. 2 shows an embodiment example for the wiring of the total system using the reference numbers from FIG. 1. In addition, the following components are shown: a foot-operated control (e.g., footswitch) FZ for controlling the motor-operated zoom body MZK and a foot-operated control (e.g., footswitch) FF for controlling the motor-operated focus drive MFT. These additional components, together with the cold-light sources KLD and KLA and the PC, which can be connected, e.g., by an RS232 interface, are connected directly to the electronics module EM and are fixedly linked to the CAN bus. Nevertheless, this fixed link to the CAN bus in the electronics module EM does not indicate a limitation of functions of the total system according to the invention because any desired number of CAN bus compliant components can be connected by means of the additional CAN bus interfaces CANN. Therefore, the fixedly linked components could also be replaced by more convenient CAN bus compliant components if necessary. Of course, it is also possible for the total system to be operated according to the invention without the above-mentioned fixedly linked components. The fixedly linked components are connected to the electronics module by plug-in interfaces; it is advantageous that the latter are clearly distinguished from the CAN bus plug-in interfaces.

It is also possible to operate the total system by means of a network (e.g., the Internet) by means of a connectable PC with a corresponding network access NW. The power supply of the individual components can be carried out by means of the CAN bus or by means of a separate power supply.

The invention is not limited to the embodiment examples shown herein. Further developments with knowledge of the art do not lead to a departure from the protective scope of the patent claims.

While the foregoing description and drawings represent the present invention, it will be obvious to those skilled in art that various changes may be made therein without departing from the true spirit and scope of the present invention.

1. A stereo microscope comprising:
a plurality of connectable or adjustable components including an illumination device, focus drive, and zoom objective;
said components having an electric control and/or an electric status detection device for detecting the switching state or the adjustment of the components; and
a connection being provided between the components for exchanging control commands or status information.

2. The stereo microscope according to claim 1, wherein the connection between the components is realized by means of an electric network.

3. The stereo microscope according to claim 1, wherein the components have a local device for processing the control commands and status information generated by the components or other components according to a given program.

4. The stereo microscope according to claim 1, wherein a central device for processing the control commands and status information of the components according to a given program is provided.

5. The stereo microscope according to claim 4, wherein the central device has a data storage which can store the settings of the components.

6. The stereo microscope according to claim 5, wherein the central device can generate from the settings of the components that are stored in the data storage control commands for the adjustment of the components according to the stored values.

7. The stereo microscope according to claim 4, wherein a display is provided which is connected to the central device and on which status information about the components connected to the central device can be displayed.

8. The stereo microscope according to claim 7, wherein information derived from the status information of the components can be displayed on the display.

9. The stereo microscope according to claim 7, wherein the display contains a device for reflecting into the eyepiece of the stereo microscope.

10. The stereo microscope according to claim 1, wherein the components have an electrically readable storage for calibration data.

11. The stereo microscope wherein the components have an electrically readable storage for calibration data according to claim 4, and wherein the central device can access the calibration data of the components and can take them into account when generating the status information.

12. The stereo microscope according to claim 11, wherein the optical resolution and/or the depth of focus or values derived therefrom can be displayed.

13. The stereo microscope according to claim 11, wherein a compensation of the stored focuses for different objectives (parfocality compensation) can be realized.

14. The stereo microscope according to claim 4, wherein the sensitivity for the focusing movement can be adjusted by the central device by evaluating an actual total magnification determined through the status information of the components.

15. The stereo microscope according to claim 4, wherein a component has a device for determining the brightness of the illumination and brightness can be regulated by the central device based on the status information of these components.

16. The stereo microscope according to claim 15, wherein the status information of the components is used for determining the brightness for selecting a suitable illumination method, and wherein this illumination method can be adjusted through the central device.

17. The stereo microscope according to claim 4, wherein a transmitted light brightfield illumination can be adapted to the visual field or object field through the central device.

18. The stereo microscope according to claim 4, wherein the central device is controllable by a footswitch or voice control.

19. The stereo microscope according to claim 4, wherein the central device can automatically control the components by means of macro programming.

20. The stereo microscope according to claim 4, wherein a common central device is provided for plurality of stereo microscopes.

21. The stereo microscope according to claim 4, wherein the stereo microscope can be operated by a personal computer.
